(19) United States
(12) Patent Application Publication
(10) Pub. No.: US 2016/0299327 A1
(43) Pub. Date: Oct. 13, 2016

(54) MICROSCOPE HAVING A TRANSMITTED ILLUMINATION DEVICE FOR CRITICAL ILLUMINATION

(71) Applicant: LEICA MICROSYSTEMS (SCHWEIZ) AG, Heerbrugg (CH)

(72) Inventors: Günter Grabher, Lustenau (AT); Robert Paulus, Hergatz (DE)

(21) Appl. No.: 14/777,766

(22) PCT Filed: Mar. 20, 2014
(86) PCT No.: PCT/EP2014/055629

§ 371 Date: Sep. 17, 2015

(30) Foreign Application Priority Data
Mar. 20, 2013 (DE) 10 2013 204 945.5

(51) Int. Cl. G02B 21/08; G02B 27/30; G02B 17/00; G02B 3/00; G02B 5/02; G02B 21/06; G02B 5/00

(52) U.S. Cl. CPC G02B 21/086; G02B 21/06; G02B 27/30; G02B 5/005; G02B 3/0056; G02B 5/021; G02B 17/006

(57) ABSTRACT

The invention relates to a microscope (100) having a transmitted illumination device (10) for critical illumination of an object (O) to be viewed, comprising:

a light source (20) comprising an LED arrangement having a light emitting surface;

a light directing unit (30, 30′) comprising a collimator (35, 35′) and a reflective enveloping surface (34, 34′), both of them for aligning light coupled into the light directing unit (30, 30′), also comprising an outcoupling surface (32, 32′), the outcoupling surface (32, 32′) possessing an outcoupling surface dimension (D), the light emitting surface of the light source (20) being smaller than the outcoupling surface (32, 32′) of the light directing unit (30, 30′), the light directing unit (30, 30′) being arranged in such a way that light emitted from the light source (20) is coupled in, and is coupled out from the outcoupling surface (32, 32′);

a condenser (40) between the outcoupling surface (32, 32′) of the light directing unit (30, 30′) and the object (O) to be viewed, the condenser having an aperture (41) having an aperture dimension (A) and being arranged so that the aperture (41) is completely irradiated with the light coupled out from the outcoupling surface (32, 32′).

### CROSS-REFERENCE TO RELATED APPLICATIONS

The present application is the U.S. national phase of International Application No. PCT/EP2014/055629 filed Mar. 20, 2014, which claims priority of German Application No. 10 2013 204 945.5 filed Mar. 20, 2013, the entirety of which is incorporated herein by reference.

### FIELD OF THE INVENTION

The present invention relates to a microscope having a transmitted illumination device for critical illumination.

### BACKGROUND OF THE INVENTION

The usual light sources utilized in light microscopy (e.g. incandescent filaments or LED arrays) are inherently very inhomogeneous, so that diffusors, usually diffusion disks, are ordinarily used. This results in a light loss in the direction of the object, however, so that the light source must be correspondingly brighter.

So-called “critical illumination,” which requires only a few optical components, is often used in simple microscopes. Usually at least the collector and field diaphragm are absent. The object is located substantially at the sample-side focal point of the condenser, which is irradiated over a large area with substantially parallel light. An aperture diaphragm that may be present is located substantially at the lamp-side focal point of the condenser Inhomogeneities in the far field of the light source are directly visible in the object image. If the area of the light source is too small, vignetting occurs in the object image.

The provision of light sources of sufficiently large area that at the same time are homogeneous is, however, very complex. Especially with higher-grade microscopes with greater demands in terms of optical quality, such light sources can be furnished only with a great deal of outlay.

High-intensity light-emitting means must be used in order to allow sufficient light intensity to be supplied for high magnifications. LEDs are favorite compact light-emitting means having many advantages. For sufficiently high-intensity illumination, however, multiple LEDs normally need to be used.

In order to allow sufficient homogeneity to be provided, especially for different magnifications, diffusers (usually diffusion disks) must be used, since the LED interstices in particular result in appreciable inhomogeneities. The use of a diffusion disk results in light loss, however, so that brighter and/or more LEDs need to be used.

Known light sources must be made larger in order to allow sufficient illumination to be supplied without vignetting. This requires on the one hand a lens system and on the other hand a relatively long optical path, which necessitates folding of the beam path. Both immensely increase the complexity.

Furnishing good-quality critical illumination is therefore very complex, the consequence being that in higher-grade microscopes what is used essentially exclusively is so-called “Köhler illumination,” which makes few demands on the light source. Additional optical elements are necessary here, however.

The subsequently published DE 10 2011 082 770 discloses a microscope having a transmitted illumination device for critical illumination. A light directing element is used to influence the directional characteristic of the light source in controlled fashion. A predefined illumination (size, brightness falloff, etc.) of a distant surface is thereby generated. This is done by reflection of the incoupled light at walls of the light directing element and/or by means of suitable structures (e.g. lenses) at the outcoupling surface.

It is desirable to have available sufficiently homogeneous critical illumination for high-grade light microscopes with little complexity.

### SUMMARY OF THE INVENTION

The present invention proposes a microscope having a transmitted illumination device for critical illumination. Advantageous embodiments are the subject matter of the description below.

The light source comprises an LED arrangement that encompasses at least one LED. The use of LEDs reduces electricity consumption and waste heat as compared with incandescent filaments, so that hardly any additional space is needed for complex cooling. An LED is advantageous with respect to conventional incandescent lamps because it has high light output and low power consumption but a small volume, and because it is dimmable with no change in color temperature. Thanks to the use of a suitable light directing unit (as explained below), it is not necessary to use conventional diffusers, so that sufficient illumination intensity can already be achieved if the LED arrangement comprises only a few LEDs, preferably between one and at most four LEDs; this simplifies the configuration and decreases inhomogeneities that result in particular from LED interstices.

A light directing unit is used to influence the directional characteristic of the light source in controlled fashion. A predefined illumination (size, brightness falloff, etc.) of a distant surface is thereby generated. The principal emission direction of the light source is preferably parallel to an optical axis of the light directing unit; preferably they are coincident.

In order to align the light radiated from the light source, the light directing unit comprises a reflective enveloping surface between an incoupling surface and an outcoupling surface, as well as a collimator. The collimator is arranged inside the light directing unit in such a way that the optical axis of the light directing unit extends through the collimator and is parallel to an optical axis of the collimator, preferably is coincident with said axis. The collimator collimates or parallelizes that angular region of the light emitted from the light source which has a small emission angle (in particular smaller than a threshold angle with respect to the principal emission direction). It is preferably embodied as a lens. Also preferably, the focal point of the lens is located in the light source. The enveloping surface serves to parallelize that angular region of the emitted light which has a larger emission angle (in particular larger than a threshold angle with respect to the principal emission direction). The configuration offers the advantage that the threshold angle can be predefined by the manufacturer and adapted to the particular conditions. A suitable threshold angle is, for example, approximately 40°. The light directing unit is preferably embodied in such a way that almost all the light emitted from the light source and coupled into the light incoupling surface becomes parallelized either by the collimator or by the enveloping surface. For this, for example, a central cavity that is delimited by an inner enveloping surface can be provided after the light incoupling surface and as far as the collimator. Passage of light through the inner enveloping surface results in refraction, with the result that light is directed toward the reflective enveloping surface. This is shown in FIG. 6.

The enveloping surface is preferably in the shape of a paraboloid of rotation or an ellipsoid of rotation. Also preferably, the enveloping surface is embodied as a first-surface mirror (advantageously, for example, for UV optics), or as a total reflection mirror that utilizes total internal reflection at the interface (e.g. plastic/air). The enveloping surface reflects light inside the light directing element.

To further improve the light-directing characteristic of the light directing unit, the latter can comprise suitable structures (e.g. lenses) on or behind the outcoupling surface. The structure either can be integrated into the outcoupling surface of the light directing unit or can be placed as a further structured optical component behind the light directing unit in the beam path. The angular characteristic and/or homogeneity in the far field can be influenced and controlled with this structured component. This can be done with structures such as Fresnel structures, diffusers, or microstructures.

The light directing unit can be regarded as a combination of individual functional components (collimator, enveloping surface and, optionally, structured optical component). By appropriate combination of these components, the emphasis in terms of optimization can be placed either on the homogeneity of the illuminated spot or on targeted control of the emission angle. Fine-tuning is possible by weighting the various properties inside the light directing unit.

In contrast to usual microscope illumination systems, imaging of the light source by the light directing unit does not take place. The outcoupling surface is large enough for full-area illumination of the condenser aperture. It has been found that the objective pupils of objectives having different magnifications are well illuminated when the outcoupling surface is larger than the maximum condenser aperture. As explained above, the light source itself has a relatively small light emission area that, in particular, is smaller than the outcoupling surface.

The light emerging from the light directing unit is sufficiently concentrated for high light efficiency, and sufficiently homogeneous for critical illumination. The system of light source and light directing unit is set up for that purpose in such a way that the light emerging from the light directing unit is emitted in an angular region of at least +/−10° and at most +/−50°, and illuminates an area 5 m away in an angular region of at least +/−5° (corresponding, for the beam paths usually used in microscopy having a round cross section, to an illuminated round area at least 87.5 cm in diameter) with intensity fluctuations of less than 50%, preferably less than 35%, more preferably less than 25%. In other words, in a region at least +/−5° around the optical axis of the light directing unit, the brightness fluctuates respectively by only at most 50%, 35%, or 25%.

A diffusion disk that is usual in microscope illumination systems for homogenization is not necessary. The light loss associated with the diffusion disk therefore does not occur, and sufficient brightness exists even with relatively few LEDs.

Preferred light directing units are substantially frustoconical, the incoupling surface being smaller than the outcoupling surface. The outcoupling surface can comprise a microlens arrangement, preferably a microlens arrangement having more than 20 microlenses, preferably in a honeycomb-like pattern.

Preferred light directing units are manufactured from transparent plastic.

The invention supplies, with little complexity, sufficiently homogeneous critical illumination for high-grade light microscopes, in particular having interchangeable objectives, i.e. for very different magnifications and thus also very different requirements regarding homogeneity and brightness.

Depending on the light directing unit used, however, inhomogeneities may continue to be present in the near field, i.e. in the region just after the outcoupling surface. It has been found that for objectives starting at magnifications of 20x, a distance from the outcoupling surface to the condenser aperture which corresponds to twice the diameter of the outcoupling surface already produces sufficient homogeneity in the object being observed.

The greater the distance from the outcoupling surface to the condenser aperture, the more homogeneous the illumination of the object field. Preferably, however, the distance is selected to be at most such that folding of the illumination beam path is not necessary. This yields cost advantages, since no deflection means are required. A distance that corresponds to four times the diameter of the outcoupling surface usually still allows a straight-line beam path between the outcoupling surface and condenser.

At low magnifications and with an accompanying small aperture, the depth of field of the image can be so large that even an outcoupling surface located relatively far away is visible in the object image. The image becomes inhomogeneous. But because the luminance required at low magnifications is also low, in such cases a diffuser (preferably a diffusion disk) can be provided in the beam path as a structured optical component. In order to make the condenser aperture (e.g. an aperture diaphragm) recognizable in the eyepiece, the diffuser is usefully arranged between the outcoupling surface and condenser aperture. It can preferably be pivoted in and out. It is preferably arranged close to the condenser aperture in order to minimize light loss.

The same also applies when high-magnification objectives are being used and an aperture (iris) diaphragm is closed very tightly. It is therefore advantageous if a diffuser is put in place as a function of aperture, i.e. if the diffuser is introduced when the aperture is smaller than a predetermined dimension (usually a predetermined diaphragm diameter).

If the light source used is bright enough, the diffuser can also be provided permanently.

In order on the one hand to permit homogeneous illumination for small aperture dimensions with accompanying large depth of field, and on the other hand to furnish sufficient luminance for high-magnification objectives, the diffuser is configured particularly advantageously so that only light in a predetermined region around the optical axis is diffused. The diffuser is preferably embodied for that purpose as a clear disk having a predefined diffusing (preferably frosted) central region. This diffuser is especially suitable for permanent placement in the beam path.

It has proven to be advantageous if the predefined region is round and has a diameter that corresponds to an illumination aperture of 0.35. (A numerical aperture of 0.35 corresponds to the usual aperture of a 20x objective.) A diameter that is up to 1.5 times larger is also suitable, since the diffusing area is then still small as compared with the total outcoupling surface, and a sufficient illumination intensity still exists at high magnifications.

There are known application instances (e.g. contrasting methods) in which the illumination aperture is stopped down even at higher magnifications. When the illumination aperture diameter approaches the predefined region, troublesome scattering effects can occur at the edge between the diffusion region and clear region. There is also a change in the slope of the square-root correlation between light intensity in the object field and iris diameter, which is expressed as a greater brightness decrease. An appropriate solution is a predefined region of non-round shape, for example in the shape of a star or other tapering structures. Thanks to the non-round (e.g. star-shaped) configuration, scattering effects at edges are minimized and unusual brightness effects do not occur as the aperture is stopped down. The frosted (substantially round) center of the non-round region should again correspond to the predefined diameter of an illumination aperture of 0.35. Alternatively or additionally, frosted areas having gradients can be used.

Further advantages and embodiments of the invention are evident from the description and the appended drawings.

It is understood that the features recited above and those yet to be explained below are usable not only in the respective combination indicated, but also in other combinations or in isolation, without departing from the scope of the present invention.

### BRIEF DESCRIPTION OF THE DRAWING VIEWS

The invention is schematically depicted in the drawings on the basis of exemplifying embodiments, and will be described in detail below with reference to the drawings.

FIG. 1 is a schematic side view of a preferred embodiment of a microscope according to the present invention, the stand foot being depicted in longitudinal section.

FIG. 2 shows a preferred embodiment of a light directing unit suitable for the invention, in a longitudinal section view (left), a plan view (center), and a perspective view (right).

FIG. 3 is a diagram of the emission characteristic of a suitable light source having a light directing unit.

FIG. 4 schematically shows a first preferred embodiment of a diffuser suitable for the invention.

FIG. 5 schematically shows a second preferred embodiment of a diffuser suitable for the invention.

FIG. 6 is a longitudinal section view of a further embodiment of a light directing unit suitable for the invention.

### DETAILED DESCRIPTION OF THE INVENTION

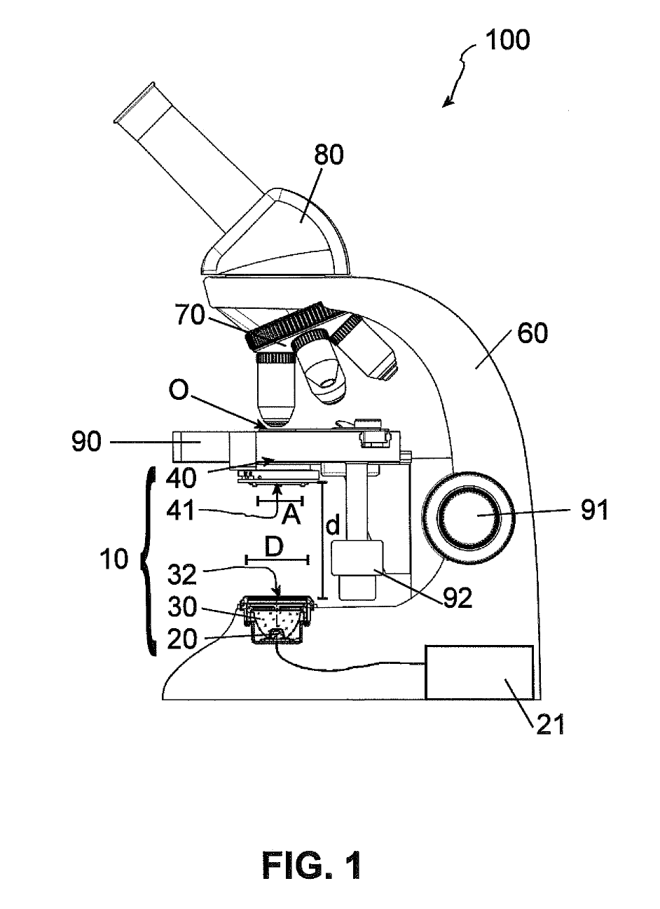

FIG. 1 is a schematic side view depicting a preferred embodiment of a microscope 100 according to the present invention, the stand foot being depicted in longitudinal section. Microscope 100 serves for viewing of an object O that is arranged on a microscope stage 90. The microscope comprises a stand 60 for carrying various microscope elements, in particular a transmitted illumination device 10, an objective turret 70 having different objectives 71, and a tube 80 having an eyepiece.

The microscope stage is movable in known fashion in a Z direction and X-Y direction via respective rotary knobs 91 and 92.

Transmitted illumination device 10 comprises a light source 20 that is embodied as an LED arrangement. An energy supply 21 serves to supply power to the LED arrangement. Arranged above LED arrangement 20 is a light directing unit 30 that has, on its side facing toward object O to be illuminated, a larger outcoupling surface 32 having a dimension D (here a diameter; it can in general be a largest or smallest longitudinal extent through a geometrical center point). The light emission surface (chip surface) of light source 20 is appreciably smaller than outcoupling surface 32 of the light directing unit, preferably half, a third, or a quarter the size.

The illumination device furthermore comprises a condenser 40 that has a condenser aperture 41 having a dimension A (here a diameter; it can in general be a largest or smallest longitudinal extent through a geometrical center point), which in the present example is embodied as an adjustable iris diaphragm. Transmitted illumination device 10 is designed for critical illumination of object O that is to be viewed. Object O is therefore located substantially at the sample-side focal point of a condenser 40, and aperture diaphragm 41 is located substantially at the lamp-side focal point of condenser 40.

In the example shown, the distance d from outcoupling surface 32 to aperture 41 is twice the outcoupling surface dimension D.

Light directing unit 30 directs the light emitted from LED arrangement 20 in such a way that it radiates out of outcoupling surface 32 in an angular region of between 10 degrees and 50 degrees. The light has, in the far field, an intensity distribution such that the intensity fluctuates by at most 50% in a region of at least 5° around the principal emission direction (see FIG. 3).

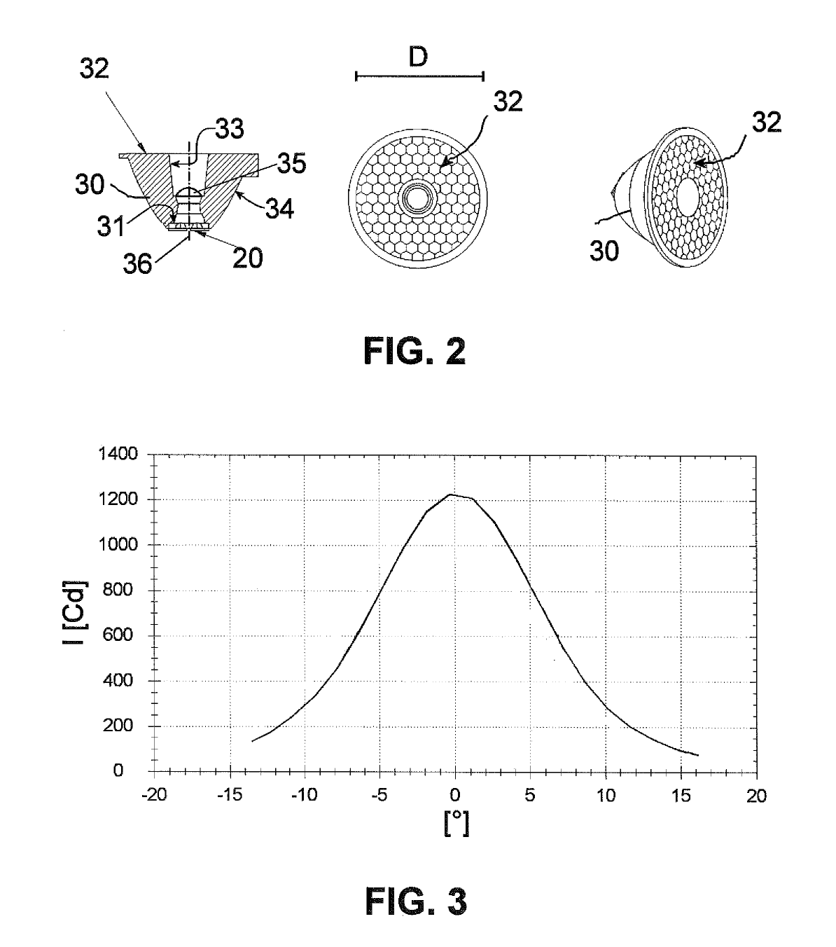

In FIG. 2 the system made up of light source 20 and light directing unit 30 is depicted, schematically in each case, in a longitudinal section view (left), a plan view (center), and a perspective view (right).

In the present example, LED arrangement 20 comprises four individual LEDs in a rectangular arrangement. It can, however, also comprise fewer LEDs, preferably only one LED. The light emitted from LED arrangement 20 constituting a light source is coupled into light directing unit 30 at an incoupling surface 31 and coupled out again at the upper outcoupling surface 32. An inner enveloping surface 33 and an outer enveloping surface 34 extend between incoupling surface 31 and outcoupling surface 32. The body delimited by inner enveloping surface 33, outer enveloping surface 34, and outcoupling surface 32 is configured from transparent plastic. Outer enveloping surface 34 is in the shape of, for example, a paraboloid of rotation and is embodied as a total reflection mirror, so that light is directed toward the outcoupling surface. The outer enveloping surface can also, however, be embodied as an ellipsoid of rotation or as a free-form surface. Inner enveloping surface 33 delimits a channel whose shape is reminiscent of a drinking vessel. A collimator, embodied as lens 35, is arranged inside the channel delimited by inner enveloping surface 33. An axis of symmetry 36 constitutes the optical axis of the light directing unit and that of the collimator, and the principal emission direction of light source 20.

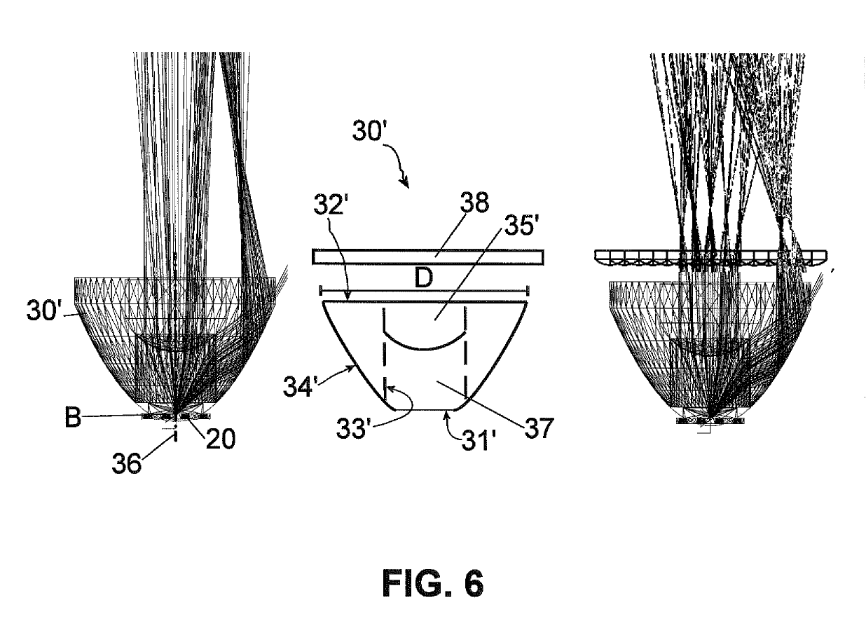

In the embodiment depicted, outcoupling surface 32 comprises a microlens arrangement, the microlenses being shaped in honeycomb-like fashion. Outcoupling surface 34 can also, however, be unstructured (as in FIG. 6) or differently structured (e.g. Fresnel lenses).

Light directing unit 30 does not image light source 20. A preferred emission characteristic of a light directing unit having an LED is depicted in FIG. 3.

In FIG. 3, luminance is plotted in a Cartesian diagram. The luminance I (in Cd) at a distance of 5 meters is plotted on the Y axis, against emission angle (in°) on the X axis; a single Luxeon Rebel white light LED was used as light source 20. It is evident that the light is directed in such a way that the emission center point is located in the region of the optical axis (0°). A certain concentration of the emitted light thus occurs, so that the essential light output is located in the region between −15° and +15° . It is furthermore evident that only a slight intensity fluctuation (less than 50%) exists between −5° and +5°.

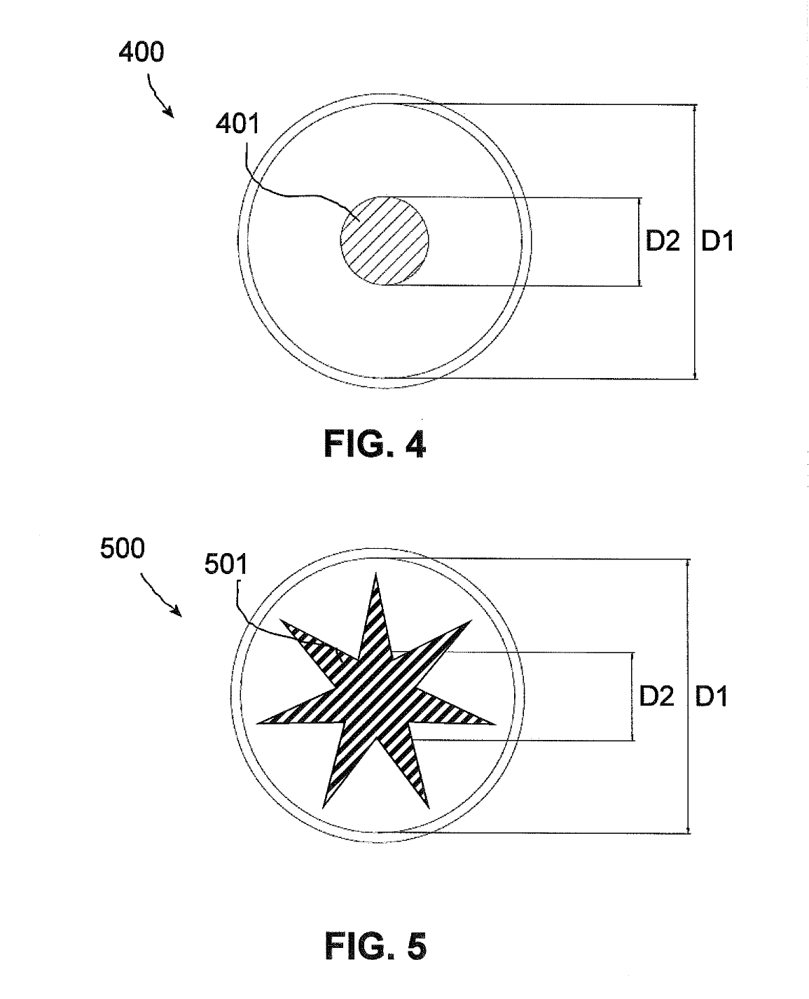

In a microscope according to FIG. 1, when the dimensions of aperture 41 (aperture diaphragm opening diameter A) are small, the depth of field can become so large that the structure of the outcoupling surface becomes recognizable in the object image. This results in undesired inhomogeneities. To eliminate these inhomogeneities, a diffuser can be provided as a structured optical component in the beam path between outcoupling surface 32 and aperture 41, preferably close to aperture 41. In a preferred embodiment of the invention the diffuser is embodied in a particular manner, as will be explained below with reference to FIGS. 4 and 5. The diffusers can be arranged permanently in the beam path, or can be pivoted in and out as a function of the aperture dimension. In this case they are pivoted in when the aperture dimension (usually a diameter) exceeds a threshold, and pivoted out when the dimension falls below it. The threshold aperture dimension preferably corresponds to a numerical aperture of 0.35.

FIG. 4 depicts a first embodiment 440, and FIG. 5 a second embodiment 500, of a diffuser of this kind Both diffusers are made up substantially of a clear disk having a diameter D1 that is embodied to be diffusing in a respective predetermined region 401, 501. For this purpose the predetermined region is preferably frosted, for example by sandblasting. Diameter D1 is selected so that the diffuser can be arranged in simple fashion in the beam path without causing shadowing. It usefully corresponds at least to a maximum possible dimension of the illumination aperture.

The embodiment according to FIG. 4 comprises a round diffusing region 401 whose dimension D2 (here a diameter; it can in general be a largest or smallest longitudinal extent through a geometrical center point) is adapted to a predetermined aperture dimension (preferably corresponding to a numerical aperture of 0.35).

Embodiment 500 according to FIG. 5 is star-shaped, a dimension D2 (smallest longitudinal extent through a geometrical center point) of a central (in particular, convex) region in the center likewise being adapted to a predetermined aperture dimension (preferably corresponding to a numerical aperture of 0.35). Alongside the central region in the center, predetermined region 501 additionally comprises tapering structures, in particular in order to avoid an abrupt light decrease during closing of the aperture diaphragm and scattering at the transition from the diffusing region to the clear region.

FIG. 6 depicts a further preferred embodiment of a light directing unit 30′, in a longitudinal section view sketching the internal structure (center), with light paths (left), and with light paths as well as a structured optical component attached in front (right), schematically in each case.

Light emitted from LED arrangement 20 constituting a light source is coupled into light directing unit 30′ at an incoupling surface 31′ and coupled out again at an upper outcoupling surface 32′. An outer enveloping surface 34′ extends between incoupling surface 31′ and outcoupling surface 32′. Extending after incoupling surface 31′ is an inner enveloping surface 33′ that delimits a cylindrical cavity 37 that is delimited at the top by a collimator embodied as lens 35′. Both optically effective surfaces of the collimator can contribute to collimation of the light, so that the exit surface need not obligatorily be plane. Focal point B of lens 35′ on the light-source side is located in the plane of light source 20.

The body delimited by inner enveloping surface 33′, outer enveloping surface 34′, collimator 35′, and outcoupling surface 32′ is embodied from transparent plastic. Outer enveloping surface 34′ has the shape of a paraboloid of rotation and is embodied as a total reflection mirror, so that light is directed toward outcoupling surface 32′. An axis of symmetry 36 constitutes the optical axis of light directing unit 30′ and that of collimator 35′, and the principal emission direction of light source 20.

Light that enters cavity 37 passes through either collimator 35′ or inner enveloping surface 33′, in the latter case being refracted toward the reflective outer enveloping surface 34′. Almost all the light coupled into incoupling surface 31′ is thus parallelized.

In the embodiment depicted, outcoupling surface 32′ is unstructured. A structured optical component 38, in the present case a microlens arrangement, can be provided behind the outcoupling surface.

What is claimed is:

1. A microscope (100) having a transmitted illumination device (10) for critical illumination of an object (O) to be viewed, comprising:
a light source (20) comprising an LED arrangement having a light emitting surface;
a light directing unit (30, 30′) comprising a collimator (35, 35′) and a reflective enveloping surface (34, 34′), both of them for aligning light coupled into the light directing unit (30, 30′), also comprising an outcoupling surface (32, 32′), the outcoupling surface (32, 32′) possessing an outcoupling surface dimension (D), the light emitting surface of the light source (20) being smaller than the outcoupling surface (32, 32′) of the light directing unit (30, 30′),
the light directing unit (30, 30′) being arranged in such a way that light emitted from the light source (20) is coupled in, and is coupled out from the outcoupling surface (32, 32′);
a condenser (40) between the outcoupling surface (32, 32′) of the light directing unit (30, 30′) and the object (O) to be viewed, the condenser having an aperture (41) having an aperture dimension (A) and being arranged so that the aperture (41) is completely irradiated with the light coupled out from the outcoupling surface (32, 32′).

2. The microscope according to claim 1, the light source (20) being arranged at the light-source-side focal point (B) of the collimator (35, 35′).

3. The microscope according to claim 1, the outcoupling surface dimension (D) being larger than the aperture dimension (A).

4. The microscope according to claim 1, the distance (d) from the outcoupling surface (32, 32′) to the aperture (41) being at least twice and at most four times the outcoupling surface dimension (D).

5. The microscope according to claim 1, the aperture (41) being arranged at the light-source-side focal point of the condenser (40).

6. The microscope according to claim 1, the beam path between the outcoupling surface (32, 32′) and condenser (40) not being folded.

7. The microscope according to claim 1, the aperture dimension (A) being variably definable by way of an iris diaphragm.

8. The microscope according to claim 1, a structured optical component (32, 38, 400, 500) being arranged in the beam path between the collimator (35, 35′) and the condenser aperture (41).

9. The microscope according to claim 8, the structured optical component (32, 38, 400, 500) comprising a microlens arrangement or Fresnel lens arrangement, or a diffuser (400, 500).

10. The microscope according to claim 8, wherein the structured optical component (32, 38, 400, 500) includes the outcoupling surface (32).

11. The microscope according to claim 8, the structured optical component (32, 38, 400, 500) being arranged in the beam path between the outcoupling surface (32, 32′) and the condenser aperture (41).

12. The microscope according to claim 10, the structured optical component (32, 38, 400, 500) being embodied as a clear disk having a predetermined diffusing region (401, 501).

13. The microscope according to claim 12, the diffusion region (401) being round and having a dimension (D2) that corresponds to a predetermined illumination aperture.

14. The microscope according to claim 12, the diffusing region (501) being non-round, preferably star shaped.

15. The microscope according to claim 14, wherein the diffusing region (501) includes an inner convex region having a dimension (D2) that corresponds to a predetermined illumination aperture.

16. The microscope according to claim 8, the structured optical component (32, 38, 400, 500) being pivotably mounted so that the structured optical component (32, 38, 400, 500) is pivotable into the beam path and pivotable out of the beam path.

17. The microscope according to claim 16, a mechanism being provided which pivots the structured optical component (32, 38, 400, 500) into the beam path and out of the beam path as a function of the aperture dimension (A).

18. The microscope according to claim 1, light coupled out of the outcoupling surface (32, 32′) radiating in an angular region of at least +/−10° and at most +/−50° with respect to an optical axis, and illuminating a surface 5 m away in an angular region of at least +/−5° with intensity fluctuations of less than 50%.

19. The microscope according to claim 11, wherein the structured optical component (32, 38, 400, 500) is arranged immediately adjacent to the condenser aperture (41).

20. The microscope according to claim 14, wherein the diffusing region (501) is star shaped.
